(19) United States
(12) Patent Application Publication
(10) Pub. No.: US 2014/0352216 A1
(43) Pub. Date: Dec. 4, 2014

(54) VEHICLE DOORS CLOSER AND WORKING UNIT FOR A VEHICLE DOORS CLOSER

(71) Applicants: Viktor Mykolaiovych KAPUSTNYK, Kharkiv (UA); Volodymyr Vitaliiovych SAMSONENKO, Kyiv (UA); Serhii Valeriiovych KLIEPCHEV, Kyiv (UA)

(72) Inventors: Viktor Mykolaiovych KAPUSTNYK, Kharkiv (UA); Volodymyr Vitaliiovych SAMSONENKO, Kyiv (UA); Serhii Valeriiovych KLIEPCHEV, Kyiv (UA)

(21) Appl. No.: 14/270,125

(22) Filed: May 5, 2014

Related U.S. Application Data
(63) Continuation of application No. PCT/UA2012/000055, filed on May 29, 2012.

(30) Foreign Application Priority Data
Nov. 3, 2011 (UA) A 2011 12940
Feb. 8, 2012 (UA) A 2012 01321
May 3, 2012 (UA) A 2012 05414

(51) Int. Cl. E05B 81/20; B60J 5/00; E05F 15/00; E05F 15/20; E05F 15/10; E05F 15/02

(52) U.S. Cl. CPC E05B 81/20; E05F 15/10; E05F 15/02; E05F 15/00; E05F 15/2084; E05F 15/20; B60J 5/00
USPC 49/31; 49/349

(57) ABSTRACT

Disclosed is a vehicle doors closer comprising a working unit of a vehicle doors closer, comprising a housing, having at least two mounts with clamping holes; at least two guiding elements fixed within the housing; a movable rack with a lock plate, placed within the housing of the door closer so as to move along the guiding elements; an actuation mechanism, transmission element transmitting power from the actuation mechanism to the working unit, connected with one end to the movable rack with a lock plate of the working unit, and connected to the actuation mechanism with the other end; a state detector; a control unit; and a bracket placed on the car body.

### CROSS REFERENCE TO RELATED APPLICATIONS

This application is a divisional of International Application No. PCT/UA2012/000055 filed May 29, 2012 which claims the benefit of Ukrainian Application No. a 2011 12940 filed Nov. 3, 2011, Ukrainian Application No. a 2012 01321 filed Feb. 8, 2012 and Ukrainian Application No. a 2012 05414 filed May 3, 2012, each of which are herein incorporated by reference in its entirety.

This application is related to International Application No. PCT/UA2012/000013 filed Feb. 13, 2012 which is herein incorporated by reference in its entirety.

### INCORPORATION BY REFERENCE

All publications and patent applications mentioned in this specification are herein incorporated by reference to the same extent as if each individual publication or patent application was specifically and individually indicated to be incorporated by reference.

### FIELD

The present invention relates to the field of automotive industry, particularly to a device for closing incompletely closed car doors.

### BACKGROUND

A large number of vehicle doors closers closing ajar doors of a vehicle have been disclosed. However, their operation is mostly based on modification of the lock part wherein an actuator responds to incomplete closing and operates the lock from a half-closed state to a fully closed state by retraction the door.

Particularly, U.S. Pat. No. 7,770,946 discloses a door lock device for a vehicle comprising a latch mechanism having a latch which can be rotated to pass, due to retraction, a half-latch state where the door is half closed and reach a full-latch state where the door is fully closed while the door is operated from an opened state to a closed state; a closer mechanism capable of forcedly turning the latch from the half-latch state to the full-latch state; and an actuator having an electric motor and a drive of the closer mechanism connected to the electric motor.

U.S. Pat. No. 6,422,617 disclose a door lock device for motor vehicles capable of automatically operating a door from an incompletely closed (half-closed) state to a fully closed (closed) state.

### SUMMARY OF THE DISCLOSURE

The disclosed arrangements have exhibited drawbacks, such as their relative complexity and thus high cost, large size and integration into a vehicle lock which, in its turn, imposes certain restrictions on their installation in already manufactured vehicles, or requires serious changes in design documentation of vehicles that are being launched.

It is therefore an object of the present invention to provide an unsophisticated and cost-effective vehicle doors closer, namely a device for closing ajar car doors, which would not require any modifications in the arrangement of a door lock, and which would be suitable for installation both in new cars with standard door operation and in earlier released cars, or which might be offered as an option for production vehicles.

The said object is achieved by the proposed universal vehicle doors closer comprising
a working unit of a vehicle doors closer, comprising a housing having at least two mounts with clamping holes; at least two guiding elements fixed within the housing; a movable rack with a lock plate placed within the housing of the door closer so as to move along the guiding elements;
an actuation mechaninism,
a transmission element transmitting power from the actuation mechanism to the working unit, connected with its one end to the movable rack with a lock plate of the working unit, and connected to the actuation mechanism with the other end,
a state detector,
a control unit, and
a bracket placed on the car body.

According to one of the embodiments, the working unit has four mounts with clamping holes.

According to another embodiment, the guiding element is made in the form of at least two rolling contact bearings which may be placed in a row.

The door closer housing may also have no pilot bearings. In this case, the movable rack with a lock plate moves due to sliding in the housing, which may be facilitated by lubrication of the rack, or by to the use of a sliding train of gears.

According to yet another embodiment, the guiding element is made in the form of a guidebar having a projecture.

According to one more embodiment, the guiding element is made in the form of a roller guide.

At the same time, the movable rack has at least one guiding groove having dimensions adjusted to those of the bearing, the roller guide or the projecture of the guidebar

An actuation mechanism of a vehicle doors closer can comprise an electric actuator, a hydraulic power drive or a pneumatic actuator, a transmission element transmitting power from an actuation mechanism to a working unit made in the form of a power element or a rotating element.

A power element may be in the form of a rigid hinged arm consisting of at least one section; a rod; a steel cable or a steel wire.

A rotating element may be in the form of a rigid hinged arm consisting of at least one section; a steel cable or a helical screw.

When a steel cable or a steel wire is used as a transmission element transmitting power from the actuation mechanism to the working unit, they may be optionally enclosed within a housing.

Furthermore, one may use guiding or fixing elements for guiding or fixing an actuation mechanism, such as a cable, a wire or a rigid hinged arm, inside the doors of a vehicle in order to prevent their uncontrolled move.

According to one of the embodiments, the state detector includes a stage, a microswitch, a sealed contact, a light-sensitive detector or a volume sensor.

The state detector is responsible for the activation of the closing mechanism retraction the door to the fully closed state in case where the door is not fully closed. The state detector may be placed both within the door closer housing, and outside the housing. For example, when a stage is used as the state detector, it is placed within the door closer housing and responds to the placing of the bracket in the working groove of the door closer. In case where, for example, a sealed contact or a light-sensitive detector is used as a state detector, they may be placed within any part of the door or the car body as long as such a state detector is capable of detecting insufficient closing of the door.

According to a preferred embodiment, an electric actuator is made in the form of an electric motor with a worm reduction unit to which a lever is connected, to which the power transmission element, such as a rigid hinged arm, a rod, a steel cable or a steel wire, is attached, while the lever can have a movement restraint device.

It should be noted that the type of an electric actuator is not limited to an electric motor with a worm reduction unit, and may be in the form of any suitable device, for example an electric motor with a rack, an electromagnetic retraction device, etc.

Moreover, the actuation mechanism may comprise a return mechanism which may be made in the form of at least one spring.

Also, a helical screw may be used as a power transmission element. In this case, a movable rack with a lock plate has a transformation element transforming turning effort into translational motion, such as a screwed connector, providing for the movement of the rack with a lock plate along the helical screw, wherein the motion of the rack with a lock plate along the helical screw is provided by the rotation of the helical screw by a hydraulic power drive with a geared ledge or a rotating cable connected to an electric actuator.

According to the most preferred embodiment, a screwed connector, such as a nut, may be used as a transformation element transforming turning effort into translational motion.

According to yet another embodiment, the bracket has a bearing at its end.

Yet another object of the invention is a working unit of a vehicle doors closer, comprising
a housing having at least two mounts with clamping holes;
at least two guiding elements fixed within the housing;
a movable rack with a lock plate placed within the housing of the door closer so as to move along the guiding elements.

According to one of the embodiments, the working unit has four mounts with clamping holes.

According to another embodiment, the guiding element is made in the form of at least two rolling contact bearings which may be placed in a row.

According to yet another embodiment, the guiding element is made in the form of a guidebar having a projecture.

According to another embodiment, the guiding element is made in the form of a roller guide.

At the same time, the movable rack has at least one guiding groove having dimensions adjusted to those of the bearing, the roller guide or the projecture of the guidebar.

The key characterizing feature of the proposed vehicle doors closer is its autonomy from the door lock and hinges, namely it is installed separately from the lock and is in no way linked to the same.

The proposed arrangement ensures the stroke of the retraction mechanism from 1 to 20 mm, which is sufficient to reach the closed state of vehicle doors.

At the same time, retraction force may vary between 10 to 200 kg and depends on the capacity of the used electric actuator, which, in its turn, depends on the weight of the vehicle doors that require closing.

### BRIEF DESCRIPTION OF THE DRAWINGS

FIG. 1—general view (schematic) of the vehicle doors closer.

FIG. 2—a view of the working unit of the vehicle doors closer with a guiding element made in the form of a guidebar.

FIG. 3—a view along the line A-A of the working unit of a vehicle doors closer with a guiding element made in the form of a guidebar.

FIG. 4—a view of the working unit of a vehicle doors closer with a guiding element made in the form of rolling contact bearings.

FIG. 5—a view along the line A-A of the working unit of a vehicle doors closer with a guiding element made in the form of rolling contact bearings.

FIG. 6—a view along the line B-B of the working unit of a vehicle doors closer with a guiding element made in the form of rolling contact bearings.

### DETAILED DESCRIPTION

Below is provided a description of one of the embodiments, which shall not be construed as limiting the scope of the invention. This practical embodiment is used as an illustration for carrying out the invention.

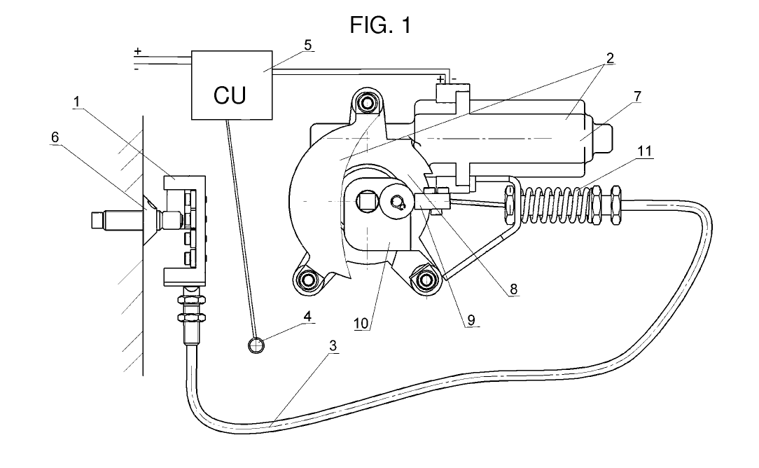

FIG. 1 shows a vehicle doors closer consisting of a working unit 1 of a vehicle doors closer, an actuation mechanism 2, a transmission element 3 transmitting power from the actuation mechanism 2 to the working unit 1, a state detector 4 linked to a control unit 5, a bracket 6 placed on the car body. At the same time, in the embodiment shown in FIG. 1, the actuation mechanism 2 is an electric actuator made in the form of an electric motor 7 with a worm reduction unit 8, to which a lever 9 is connected, to which lever 9 the power transmission element 3, such as a steel cable or a steel wire, is attached, wherein the lever 9 has a movement restraint device 10, while the actuation mechanism 2 has a return mechanism 11 made in the form of at least one spring.

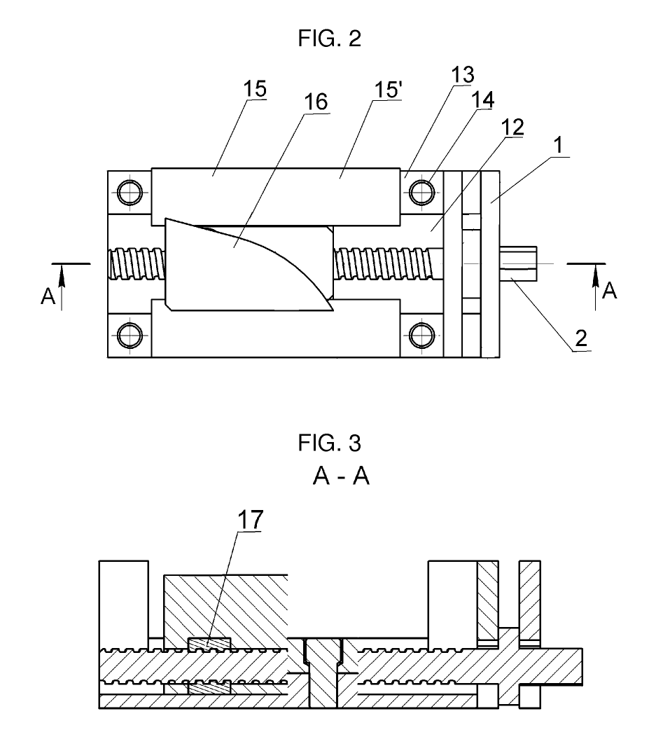

FIG. 2 shows a working unit of a vehicle doors closer 1 comprising a housing 12 having at least two mounts 13 with clamping holes 14; at least one guiding element 15 made in the form of a guidebar 15′ and fixed in the housing 12; a movable rack with a lock plate 16 placed within the housing 12 of the door closer to be movable along the guiding element 15 on the power transmission element 2.

FIG. 3 shows a movable rack with a lock plate having a transformation element transforming turning effort into translational motion, such as a screwed connector 17, providing for the movement of the rack with a lock plate along the power transmission element 2, such as a helical screw.

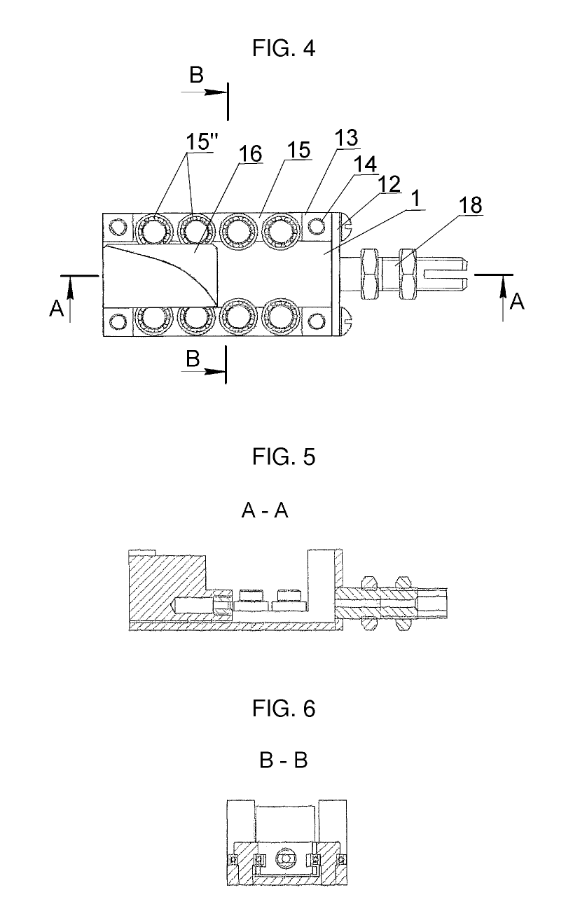

FIG. 4 shows a working unit of a vehicle doors closer 1, comprising a housing 12 having at least two mounts 13 with clamping holes 14; at least one the guiding element 15 made in the form of rolling contact bearings 15″ placed in a row and fixed in the housing 12; a movable rack with a lock plate 16 placed within the housing 12 of the door closer to be movable along the guiding element 15. In this embodiment, the working unit of the vehicle doors closer 1 has an input nozzle 18 intended for guiding the power transmission element 2, such as a steel wire or a steel cable.

FIG. 5 shows a view of the working unit of a vehicle doors closer along the line A-A.

FIG. 6 shows a view of the working unit of a vehicle doors closer along the line B-B.

The door closer operates as follows. When a vehicle door is fully closed (tight), the door closer is not activated since the contact plate 4 is deactivated in the closed door position and thus the electric circuit is open.

When a door is not closed tight, the state detector activates, and the electric circuit closes. The control unit with reaction delay is sent a charge (impulse), and if the state detector is still activated, the control unit 5 switches on the power of the electric actuator 2; the electric motor 7 rotates the reduction unit 8 which sets the power transmission element 3 in motion and sets the rack with the lock plate 16 in translational motion along the guiding element 15 inside the door closer housing 12 towards the bracket 6, contacting which results in transformation of the translational motion of the lock plate 16 in the translational motion of the door with the door closer placed therein, and in the direction perpendicular to the movement of the lock plate 16, which results in closing the door; namely in passing the door from a non-closed state into a fully closed state. When the door is fully closed, the system is switched off, and the rack with a lock plate is moved to its initial position due to the return mechanism 11 or due to the rotation of the motor in backward direction.

The control unit 5 is made with reaction delay in order to avoid activation of the door closer without actual need and to make sure that it is activated only when a door is not fully closed and there is a constant signal from the state detector, for example a constant contact of the bracket with a stage or an interaction between a sealed contact and a magnet.

A working unit of a vehicle doors closer may be installed both vertically and horizontally, and the operation movement of the rack with a lock plate may be both downward and upward depending on installation options.

A housing of a working unit of a vehicle doors closer may be manufactured both of a metal and plastic with sufficient durability, or may be made of a combination of materials. A rack with a lock plate is made of a metal to ensure long life cycle of a working part.

The bracket is universal and it may have a bearing at its end. The height of the bearing therein may change depending on the distance between the door and a mount or a car body. Such setting is very simple and is used to provide exact activation of the state detector.

When the electric circuit closes, for example, electric motor rotates the reduction unit with the lever; the lever moves radially and the radius depends on the required force and operational stroke. The radius of the stroke is set upon installation. The lever makes one turn which ensures lifting and lowering the lock plate.

The time of activation and return to the previous position of the lock plate is from one to several seconds.

Since power interruption does not necessarily guarantee stopping of the mechanism at the final stage of the working cycle, the lever movement is restricted by a movement restraint device, which ensures that the lever makes one turn.

During the next cycle the control unit changes power polarity in the electric motor, and the lever moves backwards, which does not change the mode of functioning.

Furthermore, a movement restraint device may be substituted by an electronic movement detector, for example, a light-sensitive element which detects rotation of the lever and switches of the electric motor following one turn of the lever.

To ensure that the rack with the lock plate returns in its initial positions, it may be optionally connected to a return mechanism which may be made, for example, with the use of at least one spring.

The control unit sets the actuation time at 2 seconds, which is determined upon installation to avoid the need to activate the door closer without actual need and to make sure that the same is activated only when the door has taken a fixed position, namely is not completely closed. The control unit may function as an automatic reversing unit for reversing polarity, it may control the processes of switching on and switching off, which secures a delay in switching on and automatic switching off, etc.

Furthermore, a control unit may have a preventive block which prevents jamming foreign objects between a housing of a vehicle and a door. If the power capacity consumed by an actuation mechanism, for example an electric motor, is above a certain upper limit, a control unit qualifies this as an obstacle for the operation of a vehicle doors closer, thus it switches off the electric motor and launches its backward operation resulting in the release of a jammed object and returning of a rack with a lock place to its initial position.

A rigid hinged arm which may consist of at least one section, a rod, a steel wire or a steel cable may be used as a power transmission element. As mentioned above, as a power transmission element use is preferably made of a steel cable or steel wire enclosed within a housing, which is necessary to control movement. Such a steel cable or wire ensures lifting and lowering of the rack with the lock plate, which enhances durability of the mechanism and its silent operation. At the same time, the steel cable or wire enclosed within a housing may be fixed on the door with guide rods. In an alternative embodiment, when a steel cable or wire is used as the actuator, at least one tension roller may be used to control movement. In this case, there is no need to use a protective housing.

In case where a hydraulic power drive or a pneumatic actuator is used as an actuation mechanism, it is preferable that a power transmission element, such as a helical screw, is used, which results in the movement of a rack with a lock plate along a helical screw due to transformation of turning effort into translational motion with the use of a screwed connector, such as a nut.

The developed vehicle doors closer is very compact and simple. It may be installed at any place in the inner part of a vehicle door having the width from 25 mm. At the same time, an electric actuator may be installed separately and may be connected to the housing of a door closer through an actuator, which allows installing the door closer at any angle without changing the length movement of gripping device, which makes this arrangement universal.

It will be apparent that the present invention is not limited to the specific embodiments discussed herein and that the specification illustrates the present invention. It will also be apparent to a person skilled in the art that various modifications can be made to this invention without departing from the scope of the claims.

1. A vehicle door closer comprising
a working unit of a vehicle door closer, comprising a housing, having at least two mounts with clamping holes; at least two guiding elements fixed within the housing; a movable rack with a lock plate, placed within the housing of the door closer so as to move along the guiding elements;
an actuation mechanism,
transmission element transmitting power from the actuation mechanism to the working unit, connected with one end to the movable rack with a lock plate of the working unit, and connected to the actuation mechanism with the other end.,
a state detector,
a control unit, and
a bracket placed on the car body.

2. The vehicle door closer according to claim 1, wherein the working unit has four mounts with clamping holes.

3. The vehicle deers door closer according to claim 1, wherein the guiding element is made in the form of at least two rolling contact bearings.

4. The vehicle door closer according to claim 3, wherein the guiding element is made in the form of rolling contact bearings placed in a row.

5. The vehicle door closer according to claim 1, wherein the guiding element is made in the form of a roller guide.

6. The vehicle door closer according to claim 1, wherein the guiding element is made in the form of a guidebar, having a projecture.

7. The vehicle door closer according to claim 6, wherein the movable rack has at least one guiding groove having dimensions adjusted to those of the projecture of the guidebar.

8. The vehicle door closer according to claim 1, wherein an actuation mechanism comprises an electric actuator, a hydraulic power drive or a pneumatic actuator.

9. The vehicle door closer according to claim 1, wherein a transmission element transmitting power from the actuation mechanism to the working unit is made in the form of a power element or a rotating element.

10. The vehicle door closer according to claim 9, wherein the power element is a rigid hinged arm comprising at least one section; a rod; a steel cable or a steel wire.

11. The vehicle door closer according to claim 9, wherein the rotating element is a rigid hinged arm comprising at least one section; a steel cable or a helical screw.

12. The vehicle door closer according to claim 11, wherein the steel cable or a steel wire is optionally enclosed within a housing.

13. The vehicle door closer according to claim 1, wherein a state detector is made in the form of a stage, a microswitch, a sealed contact, a light-sensitive element or a volume detector.

14. The vehicle door closer according to claim 8, wherein an electric actuator is made in the form of an electric motor with a worm reduction unit to which a lever is connected, to which lever a power transmission element, such as a rigid hinged arm, a rod, a steel cable or a steel wire, is attached.

15. The vehicle door closer according to claim 14, wherein the lever has a movement restraint device.

16. The vehicle door closer according to claim 14, wherein the actuation mechanism has a return mechanism.

17. The vehicle door closer according to claim 16, wherein the return mechanism is made in the form of at least one spring.

18. The vehicle door closer according to claim 11, wherein a helical screw is used as a power transmission element.

19. The vehicle door closer according to claim 18, wherein the movable rack with a lock plate has a transformation element transforming turning effort into translational motion, such as a screwed connector, providing for the movement of the rack with a lock plate along the helical screw.

20. The vehicle door closer according to claim 19, wherein the movement of the rack with a lock plate along the helical screw is provided by the rotation of the helical screw by a hydraulic power drive with a geared ledge or a rotating cable connected to the electric actuator.

21-27. (canceled)
